(19) United States
(12) Patent Application Publication
(10) Pub. No.: US 2011/0033571 A1
(43) Pub. Date: Feb. 10, 2011

(54) MOLD DEGATER

(76) Inventor: Dan Chittle, McGregor (CA)

Correspondence Address: CARLSON, GASKEY & OLDS, P.C., 400 WEST MAPLE ROAD, SUITE 350, BIRMINGHAM, MI, 48009, US

(21) Appl. No.: 12/910,121

(22) Filed: Oct. 22, 2010

Related U.S. Application Data
(62) Division of application No. 12/400,210, filed on Mar. 9, 2009.
(60) Provisional application No. 61/035,152, filed on Mar. 10, 2008.

(51) Int. Cl. B29C 45/38

(52) U.S. Cl. 425/553

(57) ABSTRACT

A mold assembly and method of operation utilizes a degater for separating plastic in runners and gates from a desired completed part prior to curing of the plastic material to provide desirable cut on completed part. Cutting edges of the degater are disposed proximate to the gates to trim excess plastic from a completed part prior to curing or hardening of the plastic part.

### CROSS REFERENCE TO RELATED APPLICATION

This application is a divisional of U.S. Application Ser. No. 12/400,210 filed on Mar. 9, 2009, which claims priority to U.S. Provisional Application No. 61/035,152 filed on Mar. 10, 2008.

### BACKGROUND OF THE INVENTION

This invention generally relates to mold for fabricating plastic parts. More particularly, this invention relates to a mold including a device for removing excess plastic.

A conventional mold includes first and second mold halves that form a cavity that define the size and shape of the part. The cavity is filled with plastic through a series of passages commonly referred to as runners and enters the cavity through openings commonly known as gates. Plastic within the gate cures just as the plastic part does and remains attached to the plastic part once the plastic is cured. In some instances the gate is disposed on a visible portion of a completed part and therefore removal becomes a necessary and time consuming operation. Removal of the gates is typically a secondary process that requires cutting, trimming or some other function separate from the molding of the part. As appreciated, any time spent processing a part adds to the expense and efficiency of producing the part. Therefore it is desirable to design and develop features that speed part production and reduce costs.

### SUMMARY OF THE INVENTION

An example mold assembly and method of operation utilizes a degater for separating plastic in runners and gates from a desired completed part prior to curing of the plastic material to provide a desirable cut on a completed part.

The example mold includes a degater biased toward a cutting position by a spring. Cutting edges disposed proximate to the gates precisely trim excess plastic from a completed part prior to curing or hardening of the plastic part. Because the degater is released to separate plastic in the gate from the plastic part prior to curing, the plastic is somewhat soft and therefore provides a more visibly desirable cut.

Accordingly, the disclosed process provides for removal of the gates and runners from the plastic part within the mold, prior to complete curing of the part to reduce cycle time and potentially eliminate further out of mold processing.

These and other features of the present invention can be best understood from the following specification and drawings, the following of which is a brief description.

### BRIEF DESCRIPTION OF THE DRAWINGS

FIG. 1 is a schematic illustration of an example mold including a degating device.

FIG. 2 is a flow diagram of example method steps.

### DETAILED DESCRIPTION OF THE PREFERRED EMBODIMENT

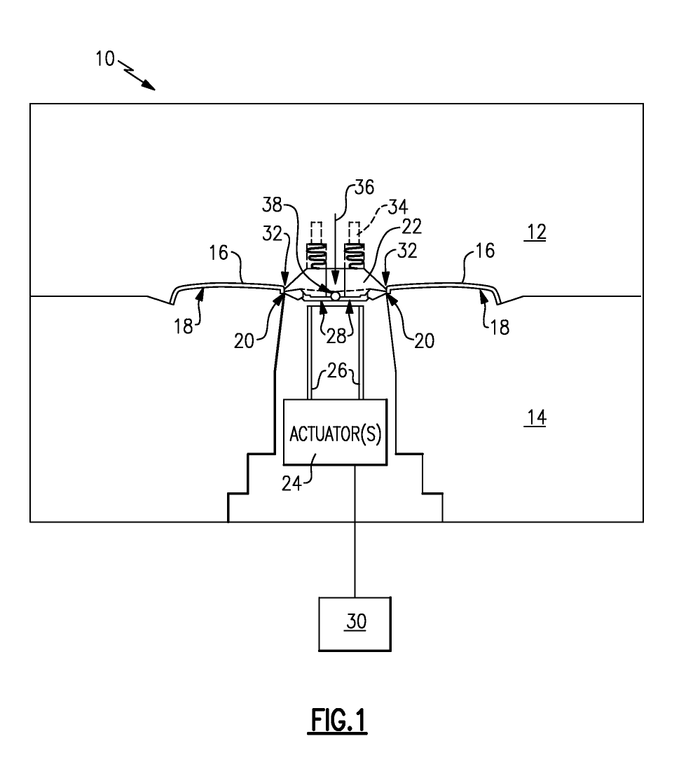

Referring to FIG. 1, a mold assembly 10 includes a cavity 12 and a core 14. The cavity 12 moves relative to the core 14 to provide for removal of a part 16. The part 16 is defined by a part cavity 18 defined between the core 14 and the cavity 12. The example mold assembly includes two part cavities 18 that are fed through central runners 28. Plastic material is feed to the part cavity 18 and fabricates the part 16. Plastic is injected through the gates 20 to fill each of the part cavities 18. During the molding process, the plastic material is injected at a pressure determined to fill each part cavity 18 and fabricate the plastic part 16 as desired. The mold assembly 10 is then maintained in the closed position until the part sufficiently solidifies to allow removal.

Removal of plastic material that hardens in the runners 28 and gates 20 typically requires an additional trimming or cutting process. The example mold assembly includes a degater 22. The degater 22 is disposed in the cavity 12 part of the mold 10 and moves in response to an actuator 24. The actuator 24 operates an actuating mechanism (shown schematically) 26 and is controlled by a controller 30. The actuating mechanism 26 holds the degater 22 in a non-cutting position during the molding process and further holds the mechanism 26 in a non-cutting position against molding pressures during a packing stage of the molding process. The actuating mechanism 26 can be any known mechanism such as for example push rods actuated by a hydraulic actuator, or other device capable of holding the degater 22 in a non-cutting position against mold pressures.

The example degater 22 is disposed between the two cavities 18 and includes cutting edges 32. The degater 22 is biased toward a cutting position by spring 34. Although a spring is disclosed, other biasing members as are known in the art are within the contemplation of this invention. The cutting edges 32 are disposed proximate to the gates 20 in order to precisely trim excess plastic from a completed part 16. The precise trimming of plastic is possible due to actuation of the degater 22 prior to curing or hardening of the plastic part. Because the degater 22 is released to separate plastic in the gate 20 from the plastic part 16 prior to curing, the plastic is somewhat soft and therefore provides a more visibly desirable cut. Plastic material 36 is injected through a central passage 38 defined within the degater 22 into the runners 28.

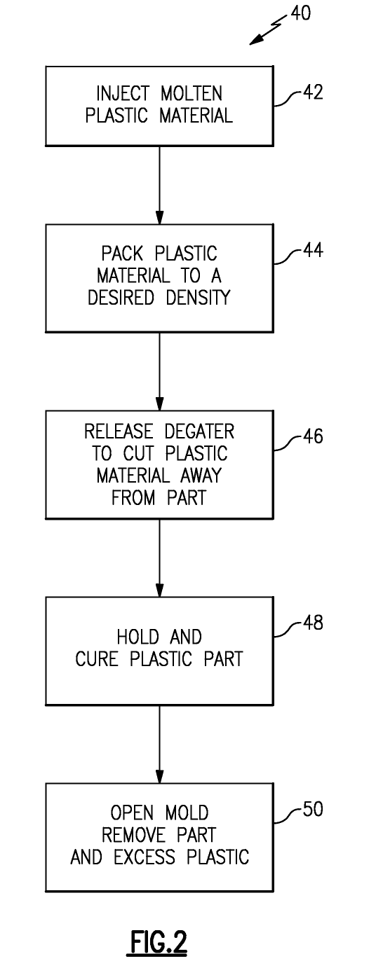

Referring to FIG. 2 with continued reference to FIG. 1, operation of the example mold assembly 10 is schematically shown at 40 and begins when molten plastic material is supplied to the gates 20 through the runners 28 indicated at 42. The gate 20 provides the opening into the part cavity 18, and the runner supplies the molten plastic material to the gates 20. Plastic that solidifies within the runners 28 and the gates 20 is removed and disposed of as they do not form part of the desired completed part. The degater 22 provides this function by cutting the plastic within the gate 20 and the runners 28 from the part 16 during the cooling or solidification process, while the mold assembly 10 is in a closed position. The degater 22 includes a cutting edge that corresponds with the gates 20 to cut and separate plastic material in the runners and gates from the plastic parts 16.

The degater 22 operates according to the following process steps. The mold assembly 10 is first closed and held closed with a defined pressure that is required to seal the part cavity 18 against molding pressures. Plastic is then injected into the part cavity 18 through the runners 28 and the gates 20 as indicated at 42. In the illustrated example, the mold assembly 10 includes two part cavities 16 to provide for molding of two parts for each mold cycle.

The plastic is held during a packing stage where pressure is applied to the plastic material to pack out the parts 16 as indicated at 44. The pack out function provides the part 16 with a desired density and also assures that the part cavity 18 is completely filled. Once the part is packed out as is desired, the degater 22 is activated as is indicated at 46.

The example degater 22 is activated in response to actuation of the actuator 24 to move the mechanism 26. The mechanism 26 holds the degater 22 in a non-cutting position until packing is complete. The mechanism 26 further includes features that prevent movement of the degater 22 and the mechanism 26 itself in response to the molding pressure. The actuator 24 moves to release the mechanism 26, which in turn releases the degater 22. The degater 22 moves into the part cavity 18 and specifically into the runner 28 and gates 20 to cut plastic in the gates 20 and runners 28 from the plastic part 16. This process is performed with the mold assembly in the closed position. The parts 16 remain in the part cavity 18 after the plastic in gates 20 and runners 28 are cut until cured as is desired as is indicated at 48.

The mold assembly 10 then opens and the parts 16 can be removed as indicated at 50. Because the gates 20 and runners 28 have been cut from the part 16, no additional trimming is required to remove the gates 20 form the parts 16. Additionally, as the gates 20 and runners 28 have already been separated form the parts 16, automated removal devices can be utilized for both the parts 16 and the gates 20. The parts 16 can be go directly to inspection or packaging, and the removed plastic in the gates 20 and runners 28 can be moved separately to a separate container for regrind or disposal.

Accordingly, the disclosed process provides for removal of the gates and runners form the plastic part within the mold, prior to complete curing of the part to reduce cycle time and potentially eliminate further out of mold processing.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A device for removing plastic runner and gate material from a plastic part comprising:
a mold including at least a first part and a second part defining a mold cavity and a plurality of runners and gates that provide a passage for injecting plastic material into the mold cavity;
a degater disposed in one of the first and second parts that includes a cutting edge corresponding with the gates;
a biasing member that biases the degater toward a cutting position where the cutting edge is moved through the gates to separate plastic material within the mold cavity from plastic material within the runners;
an actuator that holds the degater in a first position against the force of the biasing member, the actuator movable to a release the degater from the first position to the cutting position; and
a controller that controls actuation of the actuator to release the degater once plastic is injected and packed a desired amount within the mold cavity.

2. The device as recited in claim 1, wherein the degater comprises a central body portion and cutting edges extending outward from the central body portion, the cutting edges corresponding with a profile of the gates.

3. The device as recited in claim 1, wherein the first part comprises a fixed part of the mold and the second part comprises a movable part of the mold, the degater disposed within the movable part of the mold.

4. The device as recited in claim 3, wherein the fixed part of the mold includes the actuator and upon closing of the movable part onto the fixed part, the actuator moves the degater to the first position.

5. The device as recited in claim 1, including a holding member that holds the degater in the cutting position against the packing pressure within the mold cavity.

6. The device as recited in claim 1, wherein the controller actuates the actuator to release the degater prior to complete curing of the plastic material within the mold cavity, and after packing of the mold cavity to obtain a desired part density.

7. The device as recited in claim 1, wherein the gates define openings to the mold cavity on a show side of a plastic part formed by the mold cavity.
